(19) United States
(12) Patent Application Publication
(10) Pub. No.: US 2015/0250683 A1
(43) Pub. Date: Sep. 10, 2015

(54) Color changing silicone sleeves

(71) Applicant: James Richard Cross, Melbourne (AU)

(72) Inventor: James Richard Cross, Melbourne (AU)

(21) Appl. No.: 14/201,923

(22) Filed: Mar. 10, 2014

(51) Int. Cl. A61J 9/08

(52) U.S. Cl. CPC A61J 9/08; A61J 2200/72; A61J 2205/20

(57) ABSTRACT

The invention relates to a removable, protective and heat sensitive and color changing silicone sleeve for baby feeding glass bottles or containers. The silicone sleeves changes its color to a cautionary color at a stated hot temperature. Thereby imparting an idea to the caregiver that the baby food is too hot to serve or feed.

### CROSS-REFERENCE TO RELATED APPLICATIONS

This application claims the benefit of U.S. provisional application No. 61/775,695 filed on Mar. 11, 2013.

### BACKGROUND OF INVENTION

1. Field of Invention

The present invention relates to a removable, protective and heat sensitive, color changing silicone sleeve for baby feeding glass bottles or containers.

2. Description of Prior Art

Consumer market for baby products is vast and ever expanding. Specifically talking about safety products for baby bottles or containers, there are umpteen options available to the consumers. Various competitive products in the market comprise silicone sleeves based baby feeding glass bottles. These bottles consist of breakage free, heat insulating, comfortable gripping surface based silicone sleeves for protecting baby feeding glass bottles from undue damage, preventing babies from burns and facilitating easy transportation. Such silicone sleeves definitely serve the purpose of an insulating protective cover for baby feeding glass bottles or containers but fail to test the approximate temperature of the baby glass bottle contents just by viewing only, without involving the actual need of physically sensing or wrist testing the bottle contents in order to gauge the temperature of the liquid food inside.

One such example is US Pat. Application No. 20090057257 to Marcus et al. (2009) which talks about protective sleeves for containers including a body with a lumen wherein the body is configured for holding or containing the container. Although the said invention describes a protective silicone sleeve for containers, including baby bottles but the overall purpose of the invention lies in providing a protective sleeve for the underlying glass containers to avoid sudden breaking and as well acting as an insulator keeping the fluids in the receiving container warm or cold. The applicant's invention is a step ahead; it not only provides a protective encasing for the baby glass bottles but also renders a visual mechanism to gauge the approximate temperature or hotness of the baby food inside the glass bottles or containers.

Another example is U.S. Pat. No. 6,865,815 to Dunn et al. (2005) which talks about safety utensil for infants and small children formulated to change color above a predetermined temperature. The utensil primarily comprise a handle and a feeding end attached to the said handle. On the contrary, applicant's invention exhibits an innovative concept of protective, color changing silicone sleeve for baby feeding glass bottles or containers. Applicant's invention primarily caters to the fact that many a times caregivers misjudge the actual temperature of the baby food contents within the feeding bottles and thereby inviting mishaps, burns or injuries upon babies. The present invention therefore offers a substantial solution for the abovementioned problems.

### SUMMARY OF THE INVENTION

The present invention comprises a removable, protective, heat sensitive and color changing silicone sleeve for baby feeding glass bottles or containers. The present invention comes in various shapes, colors and dimensions. The present invention also embodies a cut out window on the surface for enabling the caregiver to view the measuring guide on the baby glass bottle or container. There are perforations on the surface of silicone sleeve to impart caregiver an easy visibility of the liquid food contents inside the baby feeding bottle or container. It is therefore an object of invention to overcome the drawbacks of prior art and offer improved and advantageous features in the present invention.

It is an object of invention to provide a heat sensitive color changing silicone sleeve which tends to change color when the baby food inside the feeding bottle or container reaches a stated hot temperature. The phenomenon behind the sleeve color change is thermochromism. A predetermined quantity of thermochromic additive CHROMAZONE® is mixed with silicone during the manufacturing process.

It is further an object of invention to provide a heat sensitive, color changing silicone sleeve wherein the silicone sleeve changes the original color to a cautionary color upon reaching the stated hot temperature. The cautionary color may be white but not limited to a particular color.

For a better understanding of the present invention, the matter disclosed henceforth will describe the invention and its preferred embodiments in the best possible manner.

### BRIEF DESCRIPTION OF THE DRAWINGS

The embodiments of the present invention can be better understood with the help of accompanying drawings wherein;

FIG. 1 shows the front view of color changing silicone sleeve covering the baby feeding bottle.

FIG. 2 illustrates the color changing phenomenon of silicone sleeves.

FIG. 3 shows the front view of color changing silicone sleeve in the form of a circular band.

FIG. 4 shows the front view of color changing silicone sleeve for wide neck baby bottles.

FIG. 5 represents the color transition in silicone sleeve.

### DETAILED DESCRIPTION OF THE PREFERRED EMBODIMENTS

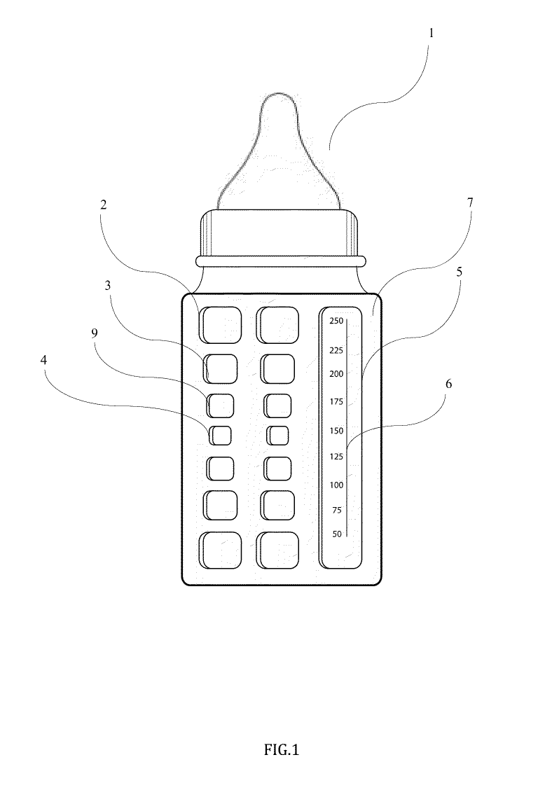

With reference to the drawings, FIG. 1 represents the front view of color changing silicone sleeve 7 protecting the baby feeding bottle 1. The surface of silicone sleeve 7 bears varied sized perforations including large sized square shaped perforation 2, midsized square shaped perforation 3, small sized square shaped perforation 9 and extra small sized square shaped perforation 4. These perforations have rounded edges. There is an elongated cut out window 5 for enabling the caregiver to view the measuring guide 6 on the baby feeding bottle 1. The cut out window 5 is an added feature due to the fact that most baby feeding bottle manufacturers include a measuring guide on the surface of baby feeding bottles. Thus, the color changing silicone sleeve 7 has an added provision for this in the form of a cut out window 5. Being removable, the silicone sleeve 7 can be used for multiple baby feeding bottles.

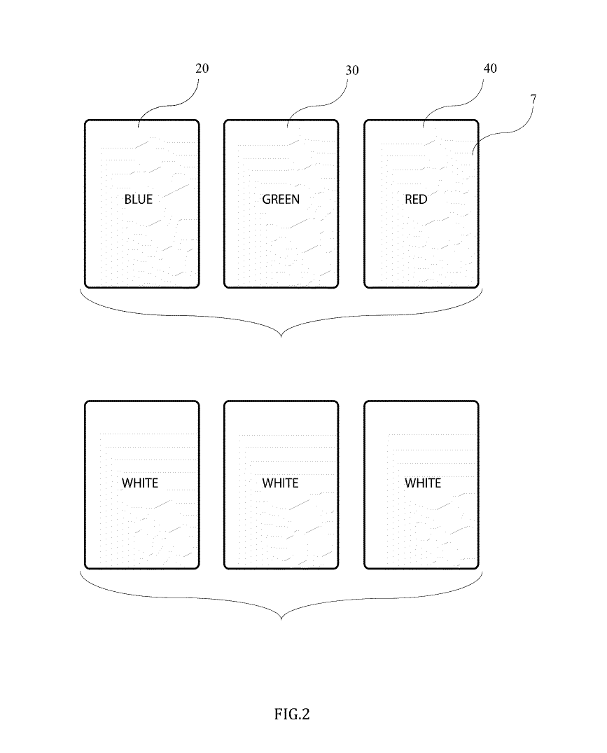

FIG. 2 represents the color changing phenomenon of silicone sleeve 7. As soon as the temperature of the liquid food contents within the baby feeding bottle 1 hits 42° C. or above, the color of blue silicone sleeve 20, green silicone sleeve 30 and red silicone sleeve 40 turns completely into a cautionary color white indicating the food is too hot to serve the baby. Upon cooling, the cautionary color returns back to the original color of the silicone sleeve. The silicone sleeve color change is contributed by Thermochromism. It is the property of substances to change color due to a change in temperature. A predetermined quantity of thermochromic additive CHROMAZONE® (either in powdered or aqueous slurry form) is mixed with silicone during the manufacturing process. The following table displays the percentage of cautionary color (in this case; white) with respect to the temperature change:

| | Temperature |
|---|---|
| % White | ° C. |
| 100 | 42.0 |
| 90 | 41.5 |
| 80 | 41.0 |
| 70 | 40.5 |
| 60 | 40.0 |
| 50 | 39.5 |
| 40 | 39.1 |
| 30 | 38.6 |
| 20 | 38.1 |
| 10 | 37.7 |
| 0 | 37.2 |

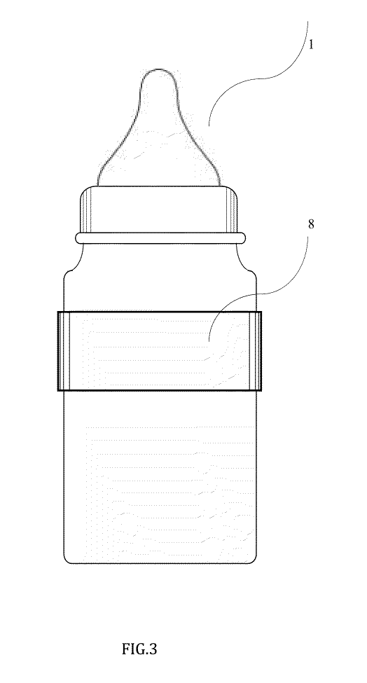

FIG. 3 represents another embodiment of the color changing silicone sleeve in the form of a circular band 8 encircling the baby feeding bottle 1. The circular band 8 offers a compact yet effective solution to the caregivers for approximating the temperature of the baby food inside the feeding bottles without having the need of putting the entire silicone sleeve encasing.

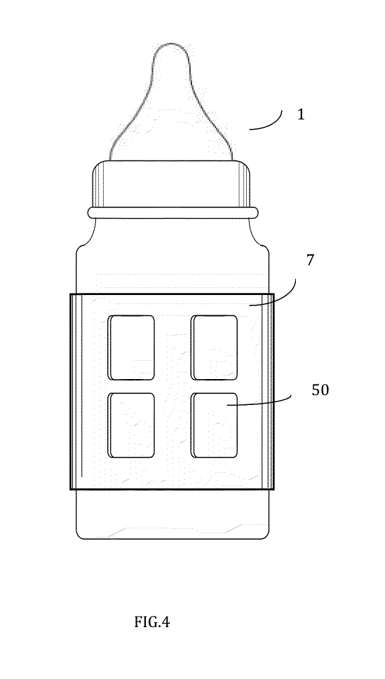

FIG. 4 represents a silicone sleeve 7 for wide neck baby feeding bottle 1 with large sized square shaped perforations 50. Through the silicone sleeve 7, the square shaped perforations 50 offer clear visibility of the baby food contents inside the baby feeding bottle 1.

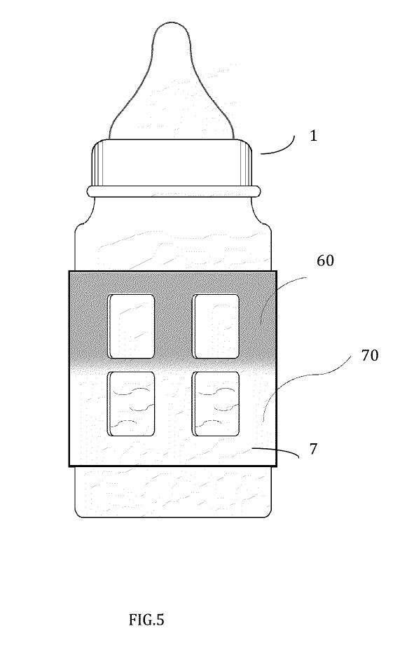

FIG. 5 represents the silicone sleeve 7 changing from the original color 70 to a cautionary color 60 when the temperature of the food content inside the baby feeding bottle 1 rises to 42° C. or above. Upon cooling most preferably around 37° C., the original color 70 of the silicone sleeve returns back.

While the written description of the invention describes the invention in the best possible mode thereof, it is expected that the ordinary skilled in the art understands variations, modifications and combinations of the preferred embodiments. The invention shall not be construed as limiting by the mentioned embodiments, methods, examples, terminologies or phraseologies, but by all embodiments and methods within the scope and ambit of the invention claimed.

What is claimed is:

1. A protective, heat sensitive and color changing silicone sleeve for baby feeding glass bottles or containers comprising:
a tubular shape with perforations on the surface;
a cut out window on the surface for viewing the measuring guide on the baby feeding bottle or container.

2. A protective, heat sensitive and color changing silicone sleeve according to claim 1, wherein the silicone sleeve is in the form of a circular band encircling the baby feeding bottle or container.

3. A protective, heat sensitive and color changing silicone sleeve according to claim 1, wherein the silicone sleeve completely changes its color to a cautionary color when the baby food inside the feeding bottle or container reaches a stated hot temperature.

4. A protective, heat sensitive and color changing silicone sleeve according to claim 3, wherein the cautionary color is white.

5. A protective, heat sensitive and color changing silicone sleeve according to claim 3, wherein the cautionary color is other than white.

6. A protective, heat sensitive and color changing silicone sleeve according to claim 1, wherein the perforations exhibit various shapes and sizes.

7. A protective, heat sensitive and color changing silicone sleeve according to claim 1, wherein the sleeve comes in various shapes, colors and sizes compatible with the dimensions of the baby feeding bottles or containers in the market.

8. A protective, heat sensitive and color changing silicone sleeve according to claim 3, wherein the original color of the silicone sleeve is fully retained when the baby food content inside the feeding bottle or container gets cooled to room temperature.

9. A protective, heat sensitive and color changing silicone sleeve according to claim 3, wherein the color changing phenomenon upon heating is contributed by the predetermined quantity of thermochromic additive mixed with silicone during the manufacturing process.

10. A protective, heat sensitive and color changing silicone sleeve according to claim 1, wherein the silicone sleeve is fully washable and dishwater safe.

11. A protective, heat sensitive and color changing silicone sleeve according to claim 1, wherein the sleeve can withstand temperatures of up to 260° C.

12. A protective, heat sensitive and color changing silicone sleeve according to claim 1, wherein the standard response temperature leading to sleeve color change may be selected based on the added thermochromic additive.

13. A protective, heat sensitive and color changing silicone sleeve according to claim 1, wherein the sleeve is removable and can be used for multiple baby feeding bottles.
